(19) United States
(12) Patent Application Publication
(10) Pub. No.: US 2007/0033120 A1
(43) Pub. Date: Feb. 8, 2007

(54) System and method for organization of financial structured products

(76) Inventor: Panayotis Takis Sparaggis, New York, NY (US)

Correspondence Address: John M. Johnson;Carter Ledyard & Milburn LLP, 2 Wall Street, New York, NY, 10005, US

(21) Appl. No.: 11/196,151

(22) Filed: Aug. 3, 2005

(51) Int. Cl. G06Q 40/00

(52) U.S. Cl. 705/35

(57) ABSTRACT

A method of analytically modeling structured products and optimizing portfolios of structured products, comprising: relating investors' financial risk/reward objectives to structured products available in an structured product database; selecting structured products that qualify for inclusion in an structured product pool that targets to meet investors' objectives; and using advanced analytical computer aided techniques including Monte-Carlo analytical simulation to evaluate risk/reward characteristics of different portfolios of structured products and determining the optimal mix of available structured products for inclusion in an structured product pool that targets a specified set of investors' risk/reward objectives.

### BACKGROUND OF THE INVENTION

In recent years, market volatility has increased the popularity and usage of “structured financial products” (SPs) in investors' portfolios. SPs represent, by non limiting example, a large class of financial products that includes notes, funds, or other securities offering: a guaranteed minimum return with full or partial—typically defined upfront—principal protection; or a guaranteed upside participation in an index (including equity, commodity, fixed income, basket portfolios, funds, economic indices such as inflation for example) or in a combination of indices with full or partial—typically defined upfront—principal protection; or a guaranteed return or upside participation in an index, a set of indices, funds or securities, that may depend on a complex set of future outcomes, but is defined upfront and carries full or partial—typically defined upfront—principal protection.

Non-limiting examples of SPs as notes include a note with a zero or non-zero coupon and fixed maturity that guarantees a minimum annualized fixed return (e.g., 1%—the return can be negative, zero or positive) and a certain percentage participation (e.g. 80%) on the cumulative return of an index (e.g. the S&P 500) during the duration of the note, if such index return exceeds the guaranteed minimum annualized return; a note with a zero or non-zero coupon and fixed maturity that guarantees the maximum of a set of returns, such as a fixed annualized return, a fixed (e.g. 75%) or variable participation (e.g. 80% up to a certain level and 50% thereafter) on an inflation index, an equity index, a basket of securities, or the cumulative outperformance of an index vs. another; a note with a zero or non-zero coupon and fixed maturity that guarantees a minimum annualized return and a certain percentage participation (e.g. 80%) on the cumulative return of an index or a linear or non-linear combination of a set of indices up to a certain ceiling (maximum annualized note return) or subject to certain linear or non-linear conditions of certain indices reaching or exceeding certain target levels or trading within a range for a certain amount of time; and a note whose return is defined in variable yearly payments that are dependent on the performance of a certain set of indices.

One of the key characteristics of SPs is a well-defined and reasonable principal (capital investment) protection, commonly 100% of initial principal. Another key feature of SPs is an upfront defined upside participation on a set of indices that are independently measured, or in funds and securities whose future performance is uncertain. The combination of these two features substantially increases downside principal protection (investors know upfront what their maximum losses can be, unlike making investments in most mutual funds, for instance) while offering potential for reasonable participation on the upside appreciation of financial products and indices. This asymmetric risk/reward, which includes well spelled-out risks to investors, combined with recent market volatility has increased investors' interest in SPs.

The “guaranteed” nature of such payments is subject to non-default of the issuer of the note or underwriter of the SP. Typically, such issuers are large, well-established financial institutions or their subsidiaries with strong credit ratings, e.g., S&P, AA, Moody's, Aa1, for example.

Differences between general mutual fund principles and the pooling of SPs into the structured product pools (SPPs) of the subject invention include: First, stocks have a history of trading and a history of how they are correlated to each other, both of which are readily available. SPs do not, as they are newly created instruments with structures that are innovative and constantly changing. Second, there is no central database for SPs, as SPs are essentially custom-made and tailored to a specific group of investors (small or large) identified by the issuer. Hence, there is no service to compare different SPs issued by different issuers at different points in time in this way. Third, SPs are analytically difficult to model. To evaluate the risk/reward relationship of a multitude of different permutations of SPs one would need to use, for example, Monte-Carlo simulation to handle the potential non-linearities in the payoff patterns of the underlying SPs. Fourth, the manager of a pool of SPs can seek to use and combine available or newly created SPs, as well as seek to express specific investment needs into an SP formulation and proactively seek issuers to structure and price it. This is analogous to combining in one's wardrobe clothes that can be bought from stores “off-the-rack” with clothes that are tailored-made, a modality not employed in generic mutual funds.

### SUMMARY OF THE INVENTION

The subject invention contemplates systems and methods of analyzing and organizing structured products (SPs) to create, analyze and manage structured product pools (SPPs) as follows:

A method of constructing and managing a database of available structured products, comprising: identifying issuers of structured products and receiving therefrom information on terms of newly issued structured products and periodic pricing of outstanding structured products; performing due diligence on issuers of structured products including at least one of examining the issuers' credit rating and changes in the issuers' credit rating, capitalization ratios, leverage, product diversification, risk management policies, size of assets under management, scope of investment activities and associated risks, composition of key personnel and major changes in key personnel; categorizing structured products by their embedded indices or products, expected return and volatility, ratings, and size; and analyzing the structured products' financial risk/reward characteristics and ranking comparable structured products according to their stated return objectives and risk parameters.

A method of analytically modeling structured products and optimizing portfolios of structured products, comprising: relating investors' financial risk/reward objectives to structured products available in an structured product database; selecting structured products that qualify for inclusion in an structured product pool that targets to meet investors' objectives; and using advanced analytical computer-aided techniques including (for example, Monte-Carlo analytical simulation) to evaluate risk/reward characteristics of different portfolios of structured products and determining the optimal mix of available structured products for inclusion in an structured product pool that targets a specified set of investors' risk/reward objectives.

A system for configuring a fund of structured products comprising: selecting the appropriate one of open-ended and closed-ended fund structure that determines how investments are made and profits are realized and distributed to investors; identifying an appropriate payment method which can combine various fixed-fee and inventive fee schemes; and establishing payment and transaction links between the fund, a fund manager, a fund custodian and a fund administrator with the investors in the fund.

A method of creating customized structured products comprising: expressing investors' financial risk/reward objectives in an structured products format; soliciting issuers to structure and competitively price structured products on a customized basis when structured products meeting the investors' financial risk/reward objectives are not readily available; expressing residual risk/reward structured product pools needs in an structured product format; and soliciting issuers to structure and price structured products on a customized basis when structured products meeting the residual risk/reward structured product pool needs are not available.

A method of managing a structured product pool comprising: monitoring structured product pool investments' appreciation and depreciation; determining whether a structured product should be liquidated from the structured product pool or be swapped with another structured product that can enhance the pool structured of products; accommodating cash transfers between the structured product pool and issuers of structured products, investors and the manager of the SPP, including manager instructions to the custodian who will execute the transfers; periodically pricing the structured product pool value accruing for all management and incentive fees; maintaining structured product pool activity information exchange between the manager and the administrator; and periodically reporting structured product pool valuation and performance information to investors.

### BRIEF DESCRIPTION OF THE DRAWINGS

These and other subjects, features and advantages of the present invention will become more apparent in light of the following detailed description of a best mode embodiment thereof, as illustrated in the accompanying Drawings in which:

FIG. 1 is a first logic process flow chart embodying the present invention; and

FIG. 2 is a second logic process flow chart embodying the present invention.

### DETAILED DESCRIPTION OF THE PREFERRED EMBODIMENTS

I. Definitions

The following terms are defined herein as follows:

Structured Products

In addition to the above examples of SPs, structured products are also defined to have the following three elements: First, SPs have a finite duration, e.g. seven years. Second, SPs offer a minimum guarantee, such as full principal back, or full principal plus a small yield per year, over their finite duration. Third, SPs offer some form of participation on the upside of an underlying financial instrument, index, or a combination of such instruments or indices.

Investors

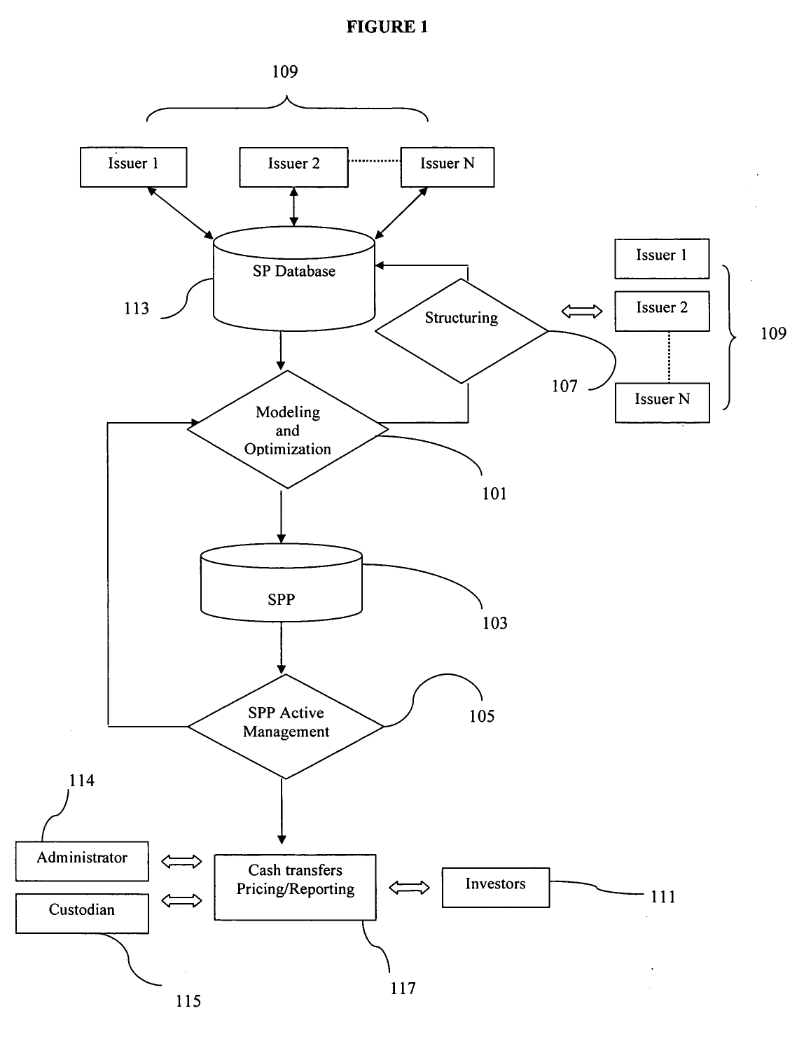

As SPs became available by a number of financial institutions a plurality of investors (111 of FIG. 1) now utilize SPs in their financial portfolios. These investors include high net worth individuals, institutions such as corporations, pension plans, foundations and endowments, family offices, money managers, private partnerships and companies.

Issuers

Issuers (109 of FIG. 1) of SPs structure, price and market these products to investors. They assume the financial obligation to deliver on the Product's stated return and yield objectives, and they back such obligation by their own credit. These issuers include commercial and investment banks, insurance companies, private banks and other financial institutions and their subsidiaries.

SP Database

A computer implemented system that receives information on SPs that are available in the marketplace, and organizes this information according to a variety of attributes including product description, the credit rating of the issuer, duration of the financial obligation, yield and return objectives, expected volatility, liquidity and size of issue.

Structured Product Pool (SPP)

The structured product pool, the focus of the subject invention, is a novel financial product that pools available structured products (SPs) and is offered to investors aiming to satisfy specific risk/reward and yield objectives. These objectives may be broadly defined. For example, investors may require at minimum to receive 100% of their investment back at the end of a specified number of years, only subject to credit risk of SP issuers; or, investors may require that they receive a minimum of a small stated yield per year over a specified number of years. In a more specific example, investors may require a minimum of 1.5% yield per year and as much participation as possible on the upside of global equities at the discretion of the SPP manager over a ten year period. The SPP can be a note, fund, separately managed account, or a private financial instrument and will be managed continuously for its stated duration.

Custodian

An independent financial institution that holds all SPP's investments. Although the SPP manager has full discretion over all investment decisions, the manager cannot transfer any cash or investments to itself other than management and incentive fees specified in the SPP memorandum or management agreement as monitored by the custodian (115 of FIG. 1).

Administrator

A financial institution or private entity that supervises and verifies the pricing of the SPs in the SPP portfolio and allocates SPP expenses, as well as profits, dividends and other cash distributions to each individual investor who has invested in the SPP is an administrator (114 of FIG. 1).

Cash Transfer, Pricing and Reporting System

The Cash Transfer Pricing and Reporting System (117 of FIG. 1) is a computer implemented system that automates the periodic pricing of the SPP and the reporting of such information, as well as performance statistics, to investors, and facilitates the cash transferring activities between the SPP, the custodian and investors.

SSP Risk/Reward Parameters

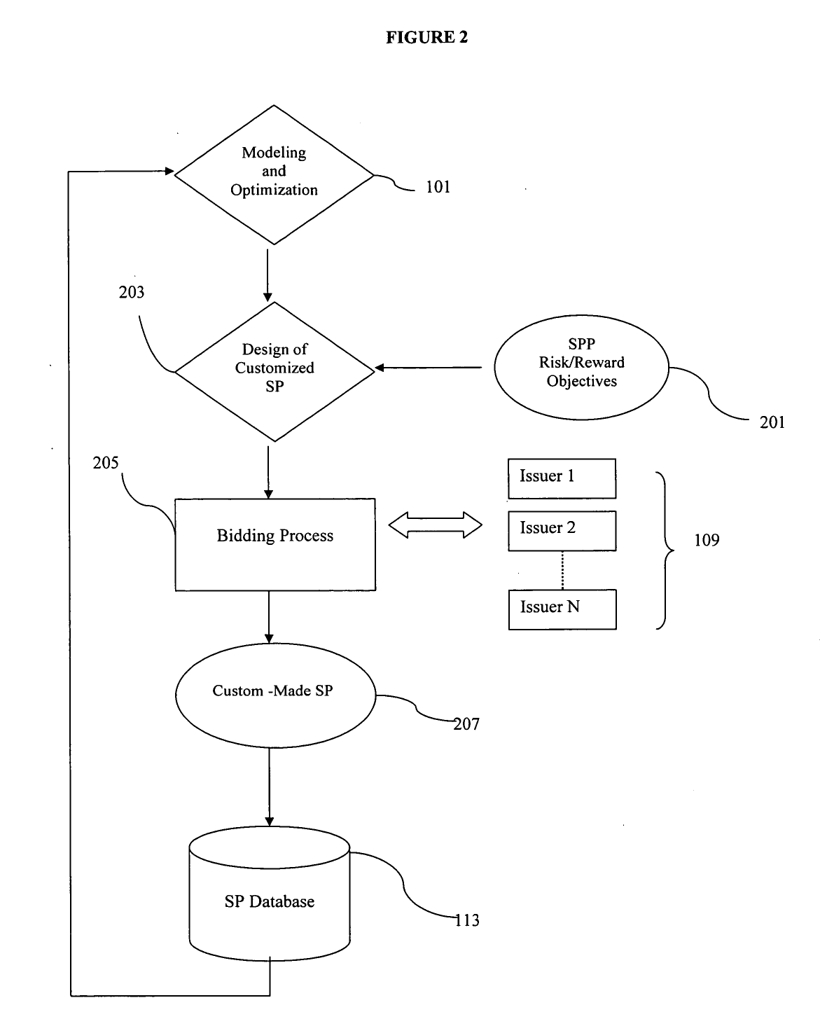

A set of parameters that define the general risk, return and yield objectives of the SSP as well as the universe of related indices, securities, funds and other financial instruments that are of interest to SSP investors. For example, a global equity SSP may seek to maximize upside participation on a broad global universe of stocks, while preserving full principal over a 7-year period (201 of FIG. 2).

Custom-Made SP

An SP that is initially designed in its general form by the manager, is submitted to potential issuers to structure and price competitively, and is finalized in all its aspects including duration, pricing and structural details following the bidding process and the selection of the issuers. This is a customized SP that the manager seeks to obtain by issuers to meet specific SPP investment needs that are not fully met by SPs available in the SP database (207 of FIG. 2).

II. Elements and Modules

The system and method of the subject invention uses a personal computer to perform the below described Modeling and Optimization Process 101, SPP Active Management Process 105, and Structuring Process 107, amongst other processes. A non-limiting example of the personal computer that can be employed to implement the system and method of the subject invention is an I.B.M.-type personal computer having, for example, a 3.2 GHz Intel Pentium 4 processor, commonly manufactured by Intel, Inc., with 1 GB of memory, and 250 GB of internal hard drive storage. In order to accommodate a higher number of users a more powerful computer, or a grid of computers connected to each other in order to carry out parallel processing and load balancing, can be utilized. The computer, or computers, use an operating environment such as Enterprise Linux ES manufactured by Red Hat, Inc. or Windows Server 2003 manufactured by Microsoft Corp. Databases are managed using database software such as 10 g manufactured by Oracle Corp. A statistical software package (such as, for example SAS/STAT manufactured by SAS) will be used to calculate the historical covariance matrices, amongst other statistical calculations that will become further apparent below. Referring to FIGS. 1 and 2, the subject invention contemplates the following elements and modules:

Modeling and Optimization Process and the Monte Carlo Simulation

Modeling and Optimization Process 101 is a computer implemented system that models individual SPs and produces probabilistic evaluations of different actuator possible SPPs 103 based upon specific return, risk and yield criteria, under numerous scenarios of financial return or price appreciation events on a variety of elements that can affect the financial performance of individual SPs over their duration, such as equity, commodity and fixed income indices, funds, financial portfolios, securities and economic indices. Monte-Carlo simulation, well known in the financial arts, can be used in handling the very large number of potential financial outcomes and in aggregating them probabilistically. For example, the system may predict that a particular actual or possible SPP is likely to produce in excess of a certain level of return with a particular probability at the end of a specified future year. Also, the Modeling and Optimization Process 101 may compare different permutations of available SPs and determine (optimize for) a particular grouping of SPs, that best fits the SPP's stated risk/reward and yield objectives.

The Monte Carlo method is a technique that involves using random numbers and probability to solve problems. The term Monte Carlo Method was coined by S. Ulam and Nicholas Metropolis in reference to games of chance, a popular attraction in Monte Carlo, Monaco.

The Monte Carlo simulation is a method for iteratively evaluating a deterministic model using sets of random numbers as inputs. This method is often used when the model is complex, nonlinear, or involves more than just a couple uncertain parameters. A simulation can typically involve over 10,000 evaluations of the model, a task which in the past was only practical using super computers, but can now be performed by personal computers. An SP typically guarantees the maximum of a set of component returns, and therefore its total expected return is by definition a non-linear function of its underlying component returns. As a result, Monte-Carlo simulation is often a very efficient mechanism to analytically handle the SP's non-linear nature of its total return function.

Monte Carlo simulation is categorized as a sampling method because the inputs are randomly generated from probability distributions to simulate the process of sampling from an actual population. One thus attempts to choose a distribution for the inputs that most closely matches available data, or best represents current state of knowledge. The data generated from the simulation can be represented as probability distributions (or histograms) or converted to error bars, reliability predictions, tolerance zones, and confidence intervals in a stochastic uncertainty propagation. An example is shown in Table 1 below:

TABLE 1

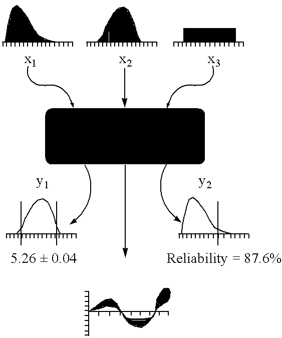

The steps in Monte Carlo simulation corresponding to the stochastic uncertainty propagation shown in Table 1 are listed below:

Step 1: Create a parametric model, y=f(x1, x2, . . . , xq).

Step 2: Generate a set of random inputs, xi1, xi2, . . . , xiq.

Step 3: Evaluate the model and store the results as yi.

Step 4: Repeat steps 2 and 3 for i=1 to n.

Step 5: Analyze the results using histograms, summary statistics, confidence intervals, etc.

(Wittwer, J. W., “Monte Carlo Simulation Basics” From Vertex42.com, Jun. 1, 2004, http://vertex42.com/ExcelArticles/mc/MonteCarloSimulation.html); (http://www.riskglossary.com/link/monte_carlo_method.htm).

SPP Active Management Process

SPP Active Management Process 105 is a computer-aided portfolio management process that constantly monitors the performance of individual SPs as well as of the SPP, and evaluates potential liquidations of existing investments, additions to the portfolio or the swapping of existing investment into other available SPs. The SPP Active Management Process 105 uses the Modeling and Optimization Process 101, above, to evaluate potential changes in the SPP portfolio. In addition, this process uses updated information to further evaluate the attractiveness of available additional or alternative individual SPs. For example, if an SP offers 80% of the upside of the Standard & Poor's 500 equity index with full principal protection over a ten year period and the S&P 500 appreciates significantly in the first year or two, the process may determine that the probability of further appreciation of the S&P 500 for the remainder of the duration of the SP is small and decide to liquidate that present SP and replace it with an alternate candidate SP.

Structuring Process

Structuring Process 107 is a computer-aided process that enhances the risk/reward or yield characteristics of a pool of available SPs. In particular, this process takes into account the investment needs of the SPP as they arise from 105 and combines them with the stated investment objectives (risk/return and yield) of the SPP 103 in order to structure and model new complementary (to existing ones) SP that could enhance the overall performance of the SPP 103. In effect, the manager of the SPP 103 during this process will evaluate the investment needs of its SPP 103 following the Management Process 105, proactively design new SPs that could enhance the SPP 103 investment performance, and finally approach issuers 109 of SPs to competitively price and issue these new SPs. Issuers of SPs are typically used to providing such customized SP designs, as often it is their clients' requests and needs that drive their issuance of SPs.

Structured Products Pool (SPP)

A structured products pool (SPP) 103 is a diversified pool of structured products that is actively managed at the discretion of the SPP's manager. An SPP 103 can target investors 111 with different risk/reward considerations and be customized to meet specific investors' needs.

SPs are often analytically difficult to model. Therefore it is expected that the SPP 103 manager will dedicate substantial resources in building the analytical infrastructure needed to manage a pool of such assets.

An SPP 103 can be structured in a number of different ways. One, the SPP 103 can be an open-ended managed account where capital is continuously managed and structured product investments can be rebalanced opportunistically. For example, if a certain structured five-year note offers 80% participation on the S&P 500 and the S&P 500 happens to deliver a 50% return during the first year one of the note, the manager may decide to profitably liquidate the note at the end of year-one or keep the note and hedge the participation on the S&P in future years. Two, the SPP 103 can be a closed-end fund, publicly traded and actively managed. Three, the SPP 103 can be a note of fixed duration that may in itself provide capital protection. Four, the SPP 103 structure can be a managed account of fund, where capital is fully deployed over a number of years (e.g. three) in a number of structured products and capital is returned to investors in stages as investments mature (e.g., notes expire) or are liquidated. In this case, the SPP may also target full return of investor's capital plus its potential appreciation within a certain number of years (e.g. 7-8 years).

A professionally managed SPP 103 will provide the following substantial benefits to interested investors:

SP Database Services

There are hundreds of SPs that are continually issued by a large number of issuers 109, e.g., private banks, commercial banks, insurance companies, and derivative product subsidiaries, for example. Sometimes, even within the same institution, different client groups issue their own products based on their own client needs. Globally, different departments within the same firm often operate autonomously.

The manager of the SPP 103 will seek to develop and establish strong relationships with all the different institutions and different departments within the same institution that may issue SPs. The manager will also develop and maintain a large, centralized, comprehensive database 113 of available structured products as well as those about to be offered in preparing the evaluation of the relative attractiveness of such instruments. This database will include details about product description, liquidity, issuer rating, size of issue, expiration times and other details.

Due Diligence and Monitoring Services

The manager will seek to perform due diligence of the product underwriters, including status and changes in their ratings, their capitalization ratios including leverage, their asset diversification and risk management policies, and other metrics that are needed to evaluate the overall credit profile of the various structured product issuers.

Among the hundreds of available SPs, many offer inferior benefits to investors 111 compared to other similar products underwritten by a different issuer. The manager will seek to compare products and identify the best ones available that may fit the SPPs investor 111 needs.

As SPs are often complex in nature, the manager will seek to develop significant analytical expertise and maintain the infrastructure needed to monitor the investment attractiveness of offered structured products on an on-going basis.

Customization Services

The manager will seek to design SPPs 103 according to risk/reward parameters either set by SPP investors 111 or targeted by the SPP 103. For example, an SPP 103 may target yield-oriented investors 111 who seek to maximize the probability of receiving a reasonable yield during the duration of their investment, or, capital-appreciation-oriented investors who seek to maximize upside participation. As an example, a 5-year note offering a minimum of 2% yield and 60% upside participation on the S&P 500 would be better suited for the former group of investors, vs. a five-year note offering a 0% minimum return and a 90% upside participation on the S&P 500 which would be better suited for the latter group of investors.

Asset Allocation and Correlation Services

Structured products are often complex and mathematically difficult to model. The manager of the SPP 103 will seek to develop a robust and comprehensive framework to analytically evaluate trade-offs between different combinations of available structured products and optimize the SPP's asset allocation according to a set of target risk/reward parameters sought by the SPP. For example, an SPP that seeks to maintain low or even negative correlation to equity markets is more likely to include notes whose upside participation is on indices that have historically exhibited low or negative correlation to the S&P 500 or other global equity indices.

While individual SPs are analytically challenging to model, modeling matrix correlations among a pool of SPs can be an even more demanding analytical task. The SPP manager will bring professional expertise in evaluating different asset combinations examined for inclusion in the SPP 103.

Structuring Services

Issuers often develop structured products based on expressed customer needs. The manager of the SPP will seek to maintain strong relationships with issuers and proactively ask issuers to develop and price custom-made products base on risk/reward targets sought by the SPP, or, residual correlation or hedging needs upon an available mix of products within the SPP. The manager may sometimes seek to competitively price such structures and exploit the potential size of the SPP investment to motivate the issuers to structure such products and obtain optimal pricing.

Pricing, Custodial and Reporting Services

The manager of the SPP will seek to open and maintain accounts with potentially dozens of different issuers and monitor the pricing and cash flows of invested products on an on-going basis. The manager will seek to simplify the reporting process to the SPP's investors by offering an integrated, comprehensive investor statement on a periodic basis. The manager will also be responsible for monitoring money transfers and cash payments (including dividends or coupons) to the SPP's investors on an ongoing basis.

The manager of the SPP can seek payment for services offered in a variety of ways, including the following:

Fixed Fee Payment

The SPP manager may seek to receive a fixed percentage payment based on assets under management, paid periodically to the manager.

Fixed and Inventive Fee Combination Payment

The SPP manager may seek to receive a fixed percentage payment based on assets under management, paid periodically to the manager, as well as a percentage participation (incentive fee) on the upside return realized on each underlying structured investment or the entire SPP. The manager may seek to receive incentive fee payments at the time when each structured product investment is liquidated or expires, or accrue incentive fee payments during the duration of the SPP and receive payment at the time when the SPP returns all its capital to investors.

Fixed and Hurdle-Rate Incentive Fee Combination Payment

Similar to the above with the addition of a hurdle-rate (minimum return) that the manager needs to deliver to investors before any inventive fee is charged.

Ladder Payments

Similar to the above with the addition of several hurdle-rates, each of which triggers a specified fixed or incentive fee payments. The ladder may be two-dimensional (matrix structure), with dependency on both SPP returns and time.

Customized SP Design

A design process that takes into account the SPP's stated risk/reward parameters as well as various residual investment needs of the SPP following SPP Active Management Process 105, and compiles a set of structural parameters that are submitted to issuers 109 of SPs for structuring and pricing a custom-made SP. For example, the manager may seek to structure an Emerging market ex-Asia equity-linked SP. The manager will submit to the issuers the desired SP's structural characteristics such as an underlying Emerging market ex-Asia index, duration of the SP, upside participation targets on the index, and downside protection targets (e.g., full principal protection at maturity) (203 of FIG. 2)

Bidding Process

A process that is used to simultaneously submit a set of structural parameters on a custom-made SP 207 to various SP issuers 109, receive the resulting structured SPs from the issuers 109, and select the one whose risk/return, yield characteristics and pricing appears most favorable to the manager of the SPP. The manager may use some of the same analytical tools used in SP Modeling and Optimization Process 101 to evaluate the relative attractiveness of the various SPs received from the issuers 109. (205 of FIG. 2)

III. Financial Structured Products Organization Examples

A first example of the logic process of FIG. 1 of the subject invention is next provided. SPP 103 seeks upside participation on global equities while preserving principal over a 7-year period. Initially, the SPP manager segments global equity universe into US, Japan, Developed Europe, Asian ex Japan, Emerging markets ex Asia. The SPP Manager initially selects US, Japan and Emerging ex Asia for inclusion in the SPP 103, believing that risk/reward is most favorable in these markets. SPP Modeling and Optimization process 101 determines the appropriate SPs for inclusion in the SPP 103, and also determines the appropriate weights of all included SPs. Following initial SPP 103 construction, the manager continually monitors the SPP 103, its performance as well as the performance of all underlying SPs using SPP Active Management Process 105. At a certain point, US equity markets perform exceptionally well and as a result the manager contemplates liquidating the US-related SPs that were included in the SPP and substitute that with two SPs, one focused on Developed Europe and another one focused on Emerging markets ex-Asia. The manager realizes that no Emerging market ex-Asia SP is currently available in the SP database 113 and decides to structure a customized SP that offers upside participation in those markets while preserving principal for the remaining of the initial 7-year period. The manager contacts the issuers 109 with its customized SP specification, receives a number of bids and selects the best one which is then included in the SP database. Finally, the manager re-optimizes the SPP to determine appropriate weights for Developed Europe and Emerging markets ex-Asia SPs.

Periodically (daily, weekly or monthly), the administrator 114 provides an SSP activity report to the director of Cash Transfer Pricing and Reporting System 1117, including overall SPP 113 valuation, expense summary and cash flow activity. At similar (typically less frequent) intervals, the administrator 114 issues valuation reports on individual investments made in the SSP 103. These reports are reviewed by the director of 117. Finally, the director forwards the individual valuation reports to the SSP investors 111. In some instances, the administrator 114 may directly issue the valuation reports to investors 111. In addition to valuation, reports issued by the director of Cash Transfer Pricing and Reporting System 117 to investors 111 may also include periodic manager commentary on SSP activity, market outlook, as well as performance statistics over a number of different time periods. In some instances, the director of Cash Transfer Pricing and Reporting System 117 will provide all such information to the administrator who will directly issue periodic comprehensive statements to individual investors 111.

A second example of the logic process of FIG. 1 of the subject invention is next given. The SPP manager decides to liquidate a particular US equity-linked SP and replace it with a certain Developed Europe SP. The manager instructs the director of Cash Transfer Pricing and Reporting System 117 of the pending transaction. The director of 117 instructs the custodian to expect a cash inflow from the issuer of the US equity linked SP and to execute a cash outflow to the issuer of the Developed Europe SP, both of specified amounts. At the same time the manager informs the administrator 114 of the two transactions, including details on units sold and bought and their pricing. The administrator 114 updates their records and revalues the SSP 113 following the transactions. Periodically (typically daily) the administrator 114 reconciles its positions with the actual assets kept at the custodian.

A third example of the logic process of FIG. 1 of the subject invention is next given. The SPP manager 101 seeks to determine appropriate weights among three SPs, one offering participation in US equities, another one offering participation in Japanese equities and a third one offering participation in European equities, which are combined in a simple SSP portfolio invested in these three SPs over a seven-year period. Underlying these three SPs are three equity indices for which historical data is available. The manager of the SSP makes the assumption that these three equity indices follow a three-dimensional normal distribution with a specified mean vector and covariance matrix. For example, the manager may use his or her own projection of expected future returns (mean vector of returns) while using a historical covariance matrix to reflect correlations among the three different indices. The manager may use a standard statistical software package (such as, for example SAS/STAT sold by SAS Inc.) to calculate the historical covariance matrix between the three indices based on a historical series of monthly returns. Then, for a given combination of the three SPs, the manager draws hundreds or thousands of random samples of the underlying equity indices (using standard software packages) and calculates the average (expected) return as well as the variance or the (expected) return of the SSP invested in that particular combination. The manager then repeats the process for many different combinations of the three SPs. Finally, the manager selects the best combination of SPs subject to a number of imposed constraints. For example, the manager may wish to maximize the expected return of the SSP, while keeping the variance of the expected return below a certain threshold level and also while maintaining a minimum (e.g. 15%) investment in each of the three SPs.

Next, an example employing the logic process of FIG. 2 is described. The manager seeks to have a Emerging Market ex-Asia equity-linked SP structured and priced. The manager initially employs Modeling and Optimization Process 101 in conjunction with SPP Risk/Reward Parameters 201 to derive Customized SP Design 203. The manager submits the SP's general objectives to various issuers 109 at Bidding Process 205. For example, the manager may seek to maximize upside participation in an underlying Emerging market index while fully preserving principal over a seven-year period. The manager receives a number of proposed SPs and evaluates the relative attractiveness of these SPs. Finally, the manager selects the one SP as Custom-made SP 207 that best serves the SPP's investment needs and notifies the issuers 109 of the final selection. The manager may select more than one Custom-made SPs 207 to invest in and include them in the SP database 113.

It will be apparent to those skilled in the art that a number of changes, modifications, or alterations to the present invention as described herein may be made, none of which depart from the spirit of the present invention. All such changes, modifications, and alterations should therefore be seen as within the scope of the present invention.

What is claimed:

1. A method of constructing and managing a computer database of available structured products, comprising:
(a) identifying issuers of structured products and receiving therefrom information on terms of newly issued structured products and periodic pricing of outstanding structured products;
(b) performing due diligence on issuers of structured products;
(c) categorizing structured products by their embedded indices; and
(d) analyzing the structured products financial risk/reward characteristics and ranking comparable structured products according to their stated return objectives and risk parameters.

2. The method of claim 1 wherein the structured products embedded indices is selected from the group consisting of products, ratings and size.

3. The method of claim 1 wherein the due diligence examination performed on issuers is selected from the group consisting of issuers' credit rating, changes in issuers' credit rating, capitalization ratios, leverage, product diversification, risk management policies, size of assets under management, scope of investment activities and associated risks, composition of key personnel and changes in key personnel.

4. The method of claim 1 wherein the structured product is selected from the group consisting of notes, funds, securities with a guaranteed minimum return with one of full and partial principal protection, and indices with one of full principal protection, partial principal protection and a guaranteed minimum return.

5. A method of analytically modeling structured products and optimizing portfolios of structured products using a computer, comprising:
(a) relating investors' financial risk/reward objectives to structured products available in an structured product database;
(b) selecting structured products that qualify for inclusion in an structured product pool that targets to meet investors' objectives; and
(c) using advanced analytical computer-aided techniques including Monte-Carlo analytical simulation to evaluate risk/reward characteristics of different portfolios of structured products and determining the optimal mix of available structured products for inclusion in an structured product pool that targets a specified set of investors' risk/reward objectives.

6. The method of claim 5 wherein the structured product is selected from the group consisting of notes, funds, securities with a guaranteed minimum return with one of full and partial principal protection, and indices with one of full principal protection, partial principal protection and a guaranteed minimum return.

7. A method for configuring a fund of structured products using a computer comprising:
(a) selecting the appropriate one of open-ended and closed-ended fund structures that determines how investments are made and profits are realized and distributed to investors;
(b) identifying an appropriate payment method which can combine various fixed-fee and inventive fee schemes; and
(c) establishing payment and transaction links between the fund, a fund manager, a fund custodian and a fund administrator with the investors in the fund.

8. The method of claim 7 wherein the structured product is selected from the group consisting of notes, funds, securities with a guaranteed minimum return with one of full and partial principal protection, and indices with one of full principal protection, partial principal protection and a guaranteed minimum return.

9. A method of creating customized structured products using a computer comprising:
(a) expressing investors' financial risk/reward objectives in an structured products format;
(b) soliciting issuers to structure and competitively price structured products on a customized basis when structured products meeting the investors' financial risk/reward objectives are not available;
(c) expressing residual risk/reward structured product pool needs in an structured product format; and
(d) soliciting issuers to structure and price structured products on a customized basis when structured products meeting the residual risk/reward structured product pool needs are not available.

10. The method of claim 9 wherein the structured product is selected from the group consisting of notes, funds, securities with a guaranteed minimum return with one of full and partial principal protection, and indices with one of full principal protection, partial principal protection and a guaranteed minimum return.

11. A method of managing an structured product pool using a computer comprising:
(a) monitoring structured product pool investments' appreciation and depreciation;
(b) determining whether a structured product should be liquidated from the structured product pool or be swapped with another structured product that can enhance the pool of structured products in the structured product pool;
(c) accommodating cash transfers between the structured product pool and issuers of structured products, investors and the manager of the structured product pool, including manager instructions to the custodian who will execute the transfers;
(d) periodically pricing the structured product pool value accruing for all management and incentive fees;
(e) maintaining structured product pool activity information exchange between the manager and the administrator; and
(f) periodically reporting structured product pool valuation and performance information to investors.

12. The method of claim 11 wherein the structured product is selected from the group consisting of notes, funds, securities with a guaranteed minimum return with one of full and partial principal protection, and indices with one of full principal protection, partial principal protection and a guaranteed minimum return.

13. A system of constructing and managing a computer database of available structured products, comprising:
(a) a component for identifying issuers of structured products and receiving therefrom information on terms of newly issued structured products and periodic pricing of outstanding structured products;
(b) a component for performing due diligence on issuers of structured products;
(c) a component for categorizing structured products by their embedded indices; and
(d) a component for analyzing the structured products financial risk/reward characteristics and ranking comparable structured products according to their stated return objectives and risk parameters.

14. The system of claim 13 wherein the structured products embedded indices is selected from the group consisting of products, ratings and size.

15. The system of claim 13 wherein the due diligence examination performed on issuers is selected from the group consisting of issuers' credit rating, changes in issuers' credit rating, capitalization ratios, leverage, product diversification, risk management policies, size of assets under management, scope of investment activities and associated risks, composition of key personnel and changes in key personnel.

16. The system of claim 13 wherein the structured product is selected from the group consisting of notes, funds, securities with a guaranteed minimum return with one of full and partial principal protection, and indices with one of full principal protection, partial principal protection and a guaranteed minimum return.

17. A system of analytically modeling structured products and optimizing portfolios of structured products using a computer, comprising:
(a) a component for relating investors' financial risk/reward objectives to structured products available in an structured product database;
(b) a component for selecting structured products that qualify for inclusion in an structured product pool that targets to meet investors' objectives; and
(c) a component for using advanced analytical computer-aided techniques including Monte-Carlo analytical simulation to evaluate risk/reward characteristics of different portfolios of structured products and determining the optimal mix of available structured products for inclusion in an structured product pool that targets a specified set of investors' risk/reward objectives.

18. The system of claim 17 wherein the structured product is selected from the group consisting of notes, funds, securities with a guaranteed minimum return with one of full and partial principal protection, and indices with one of full principal protection, partial principal protection and a guaranteed minimum return.

19. A system for configuring a fund of structured products using a computer comprising:
(a) a component for selecting the appropriate one of open-ended and closed-ended fund structures that determines how investments are made and profits are realized and distributed to investors;
(b) a component for identifying an appropriate payment method which can combine various fixed-fee and inventive fee schemes; and
(c) a component for establishing payment and transaction links between the fund, a fund manager, a fund custodian and a fund administrator with the investors in the fund.

20. The system of claim 19 wherein the structured product is selected from the group consisting of notes, funds, securities with a guaranteed minimum return with one of full and partial principal protection, and indices with one of full principal protection, partial principal protection and a guaranteed minimum return.

21. A system of creating customized structured products using a computer comprising:
(a) a component for expressing investors' financial risk/reward objectives in an structured products format;
(b) a component for soliciting issuers to structure and competitively price structured products on a customized basis when structured products meeting the investors' financial risk/reward objectives are not available;
(c) a component for expressing residual risk/reward structured product pool needs in an structured product format; and
(d) a component for soliciting issuers to structure and price structured products on a customized basis when structured products meeting the residual risk/reward structured product pool needs are not available.

22. The system of claim 21 wherein the structured product is selected from the group consisting of notes, funds, securities with a guaranteed minimum return with one of full and partial principal protection, and indices with one of full principal protection, partial principal protection and a guaranteed minimum return.

23. A system of managing an structured product pool using a computer comprising:
(a) a component for monitoring structured product pool investments' appreciation and depreciation;
(b) a component for determining whether a structured product should be liquidated from the structured product pool or be swapped with another structured product that can enhance the pool of structured products in the structured product pool;
(c) a component for accommodating cash transfers between the structured product pool and issuers of structured products, investors and the manager of the structured product pool, including manager instructions to the custodian who will execute the transfers;
(d) a component for periodically pricing the structured product pool value accruing for all management and incentive fees;
(e) a component for maintaining structured product pool activity information exchange between the manager and the administrator; and
(f) a component for periodically reporting structured product pool valuation and performance information to investors.

24. The system of claim 23 wherein the structured product is selected from the group consisting of notes, funds, securities with a guaranteed minimum return with one of full and partial principal protection, and indices with one of full principal protection, partial principal protection and a guaranteed minimum return.
